(19) United States
(12) Patent Application Publication
(10) Pub. No.: US 2013/0057630 A1
(43) Pub. Date: Mar. 7, 2013

(54) IMAGE FORMING APPARATUS AND IMAGE FORMING METHOD

(71) Applicants: Yoshimasa Inoue, Izunokuni-shi (JP); Kengo Saga, Mishima-shi (JP)

(72) Inventors: Yoshimasa Inoue, Izunokuni-shi (JP); Kengo Saga, Mishima-shi (JP)

(73) Assignee: TOSHIBA TEC KABUSHIKI KAISHA, Tokyo (JP)

(21) Appl. No.: 13/597,342

(22) Filed: Aug. 29, 2012

(30) Foreign Application Priority Data
Sep. 5, 2011 (JP) 2011-192912

(51) Int. Cl. B41J 2/01

(52) U.S. Cl. 347/104

(57) ABSTRACT

An image forming apparatus comprises a first printer, having a first print head, in which a first recording medium conveying path is linearly arranged in the horizontal direction, a second printer, having a second print head, in which a second recording medium conveying path is linearly arranged in the horizontal direction, and a conveying changeover path, arranged between the first printer and the second printer, that is configured to selectively guide a recording medium loaded in the second printer towards the first print head of the first printer therethrough.

### CROSS-REFERENCE TO RELATED APPLICATION

This application is based upon and claims the benefit of priority from Japanese Patent Application No. 2011-192912, filed Sep. 5, 2011, the entire contents of which are incorporated herein by reference.

### FIELD

Embodiments described herein relate to an image forming apparatus and an image forming method.

### BACKGROUND

An image forming apparatus has been developed which forms image on a rolled recording medium, which includes a receipt sheet and a label sheet.

Recent years, an image forming apparatus which is equipped with a receipt printer for forming an image on a receipt sheet and a label printer for forming an image on a label sheet has been developed.

However, depending on the frequency in use, there is a high possibility that either one of the print heads of the receipt printer and the label printer becomes out of order prior to the other. In this case, in the conventional image forming apparatus, it is required to reload the recording medium into the printer having a normal print head.

### BRIEF DESCRIPTION OF THE DRAWINGS

FIG. 1 is a cross-sectional view showing the structure of an image forming apparatus according to one embodiment;

FIG. 2 is a diagram showing the image forming apparatus using a cross conveying path in FIG. 1;

FIG. 3 is a block diagram showing the structure of the image forming apparatus;

FIG. 4 is a diagram showing an example of print data sent from a host computer to the image forming apparatus;

FIG. 5 is a flow chart showing operations carried out by the image forming apparatus in a normal case;

FIG. 6 is a diagram showing the operations carried out by the image forming apparatus when a label printer forms an image on a second recording medium.

### DETAILED DESCRIPTION

In accordance with one embodiment, an image forming apparatus comprises a first printer, having a first print head, in which a first recording medium conveying path is linearly arranged in the horizontal direction, a second printer, having a second print head, in which a second recording medium conveying path is linearly arranged in the horizontal direction, and a conveying changeover path, arranged between the first printer and the second printer, that is configured to selectively guide a recording medium loaded in the second printer towards the first print head of the first printer therethrough.

Embodiments of the image forming apparatus and the image forming method are described in detail below with reference to the accompanying drawings.

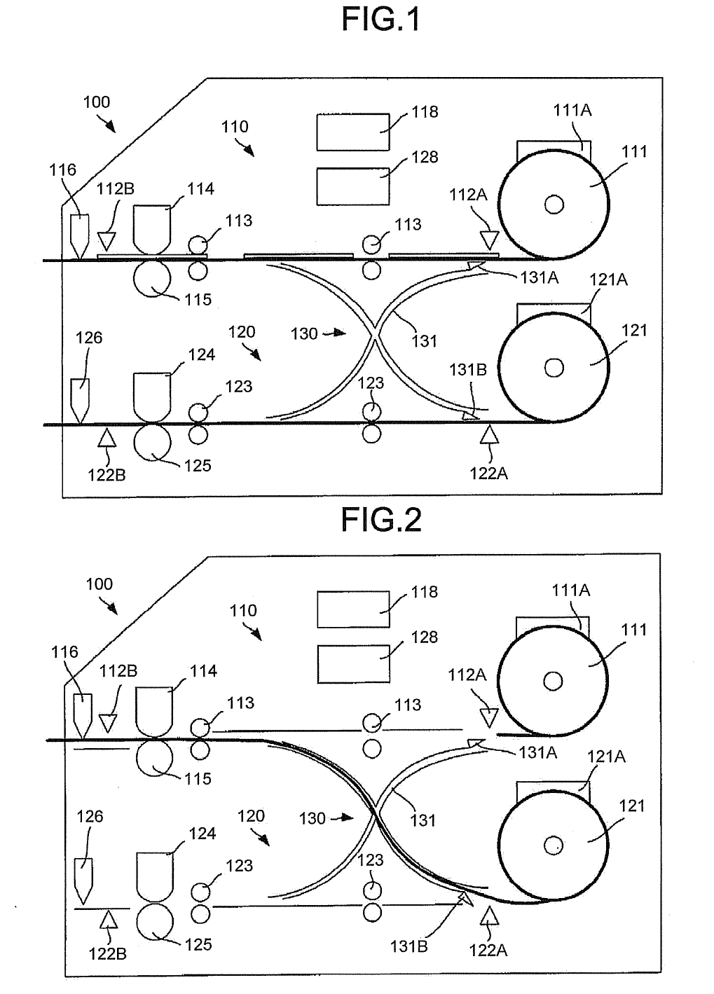

FIG. 1 is a cross-sectional view showing the structure of the image forming apparatus. As showing in FIG. 1, the image forming apparatus 100 according to this embodiment includes a label printer 110 serving as a first printer, a receipt printer 120 serving as a second printer, and a conveying changeover path 130.

The label printer 110 is equipped with a first roll driving section 111A which holds a first recording medium 111 in a rolled form and rotates the first recording medium 111 in a takeout direction and a rewind direction, a first recording medium conveying mechanism 113 which is arranged in the first recording medium conveying path, a first print head 114 for forming an image on the recording medium conveyed along the first recording medium conveying path, a first platen 115 arranged at a position opposite to the first print head 114 across the first recording medium conveying path, a first outlet sensor 112B arranged at the downstream side of the first print head 114 in the recording medium conveying direction, a first cutter 116 for cutting the recording medium and a label printer control section 118. The first recording medium conveying path is arranged linearly in the horizontal direction.

The receipt printer 120 is equipped with a second roll driving section 121A that is arranged below the label printer 110 and holds a second recording medium 121 in a rolled form to rotate the second recording medium 121 in a take-out direction and a rewind direction, a second recording medium conveying mechanism 123 which is arranged in the second recording medium conveying path, a second print head 124 for forming an image on the recording medium conveyed along the second recording medium conveying path, a second platen 125 arranged at a position opposite to the second head 124 across the second recording medium conveying path, a second outlet sensor 122B arranged at the downstream side of the second print head 124 in the recording medium conveying direction, a second cutter 126 for cutting the recording medium, and a receipt printer control section 128. The second recording medium conveying path is arranged linearly in the horizontal direction.

The conveying changeover path 130 includes a cross conveying path 131 which is arranged below the label printer 110 but above the receipt printer 120 to guide the first recording medium 111 towards the second recording medium conveying path and the second recording medium 121 towards the first recording medium conveying path, a first flapper 131A for switching the first recording medium conveying path to the cross conveying path 131, a first inlet sensor 112A arranged at the upstream side of the first flapper 131A in the recording medium conveying direction, a second flapper 131B for switching the second recording medium conveying path to the cross conveying path 131, and a second inlet sensor 122A arranged at the upstream side of the second flapper 131B in the recording medium conveying direction.

FIG. 1 shows the image forming apparatus 100 in which the first recording medium 111 is conveyed through the first recording medium conveying path and an image is printed thereon by the first print head 114, and the second recording medium 121 is conveyed through the second recording medium conveying path and an image is printed thereon by the second print head 124.

In this case, the position of the first flapper 131A shifts to form the first recording medium conveying path, and the position of the second flapper 131B shifts to form the second recording medium conveying path.

FIG. 2 is a diagram showing the image forming apparatus 100 using the cross conveying path 131. As shown in FIG. 2, the image forming apparatus 100 drives the first roll driving section 111A in the rewinding direction to rewind the first recording medium 111 until the first inlet sensor 112A is ‘ON’.

The image forming apparatus 100 also drives the second roll driving section 121A in the rewinding direction to rewind the second recording medium 121 until the second inlet sensor 122A is ‘ON’.

The image forming apparatus 100 drives the second flapper 131B to connect the conveying path with the cross conveying path 131.

The image forming apparatus 100 drives the second roll driving section 121A in the take-out direction to take out the second recording medium 121 until the first outlet sensor 112B is ‘OFF’.

Therefore, the image forming apparatus 100 is able to form images on the second recording medium 121, using the first print head 114.

The image forming apparatus 100 is also able to form images on the first recording medium 111, using the second print head 124.

In this case, the image forming apparatus 100 drives the first roll driving section 111A in the rewinding direction to rewind the first recording medium 111 until the first inlet sensor 112A is ‘ON’.

The image forming apparatus 100 drives the second roll driving section 121A in the rewinding direction to rewind the second recording medium 121 until the second inlet sensor 122A is ‘ON’.

The image forming apparatus 100 drives the first flapper 131A to switch over the conveying path to the cross conveying path 131.

The image forming apparatus 100 drives the first roll driving section 111A in the take-out direction to take out the first recording medium 111 until the second outlet sensor 122B is ‘OFF’.

The switching in the image forming on either of the recording mediums using either of the printers is carried out according to an instruction input from a control panel 214.

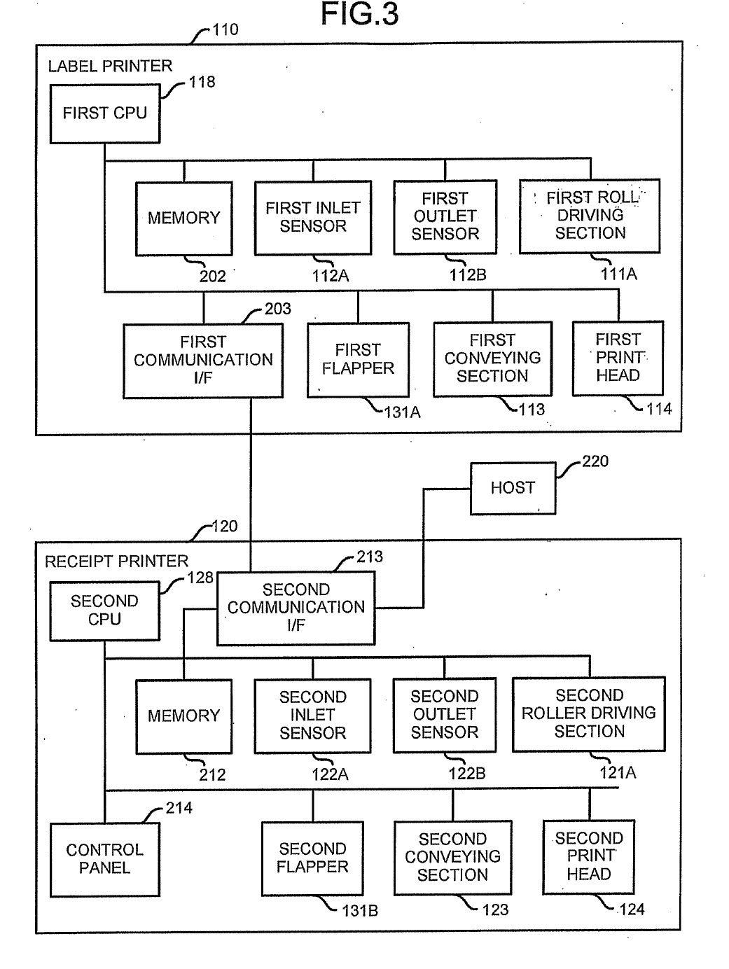

FIG. 3 is a block diagram showing the structure of the image forming apparatus 100. As shown in FIG. 3, the label printer 110 includes a first CPU serving as a first control section, a memory 202 serving as a storage device, a first inlet sensor 112A, a first outlet sensor 112B, a first roll driving section 111A, a first flapper 131A, a first recording medium conveying mechanism 113, a first print head 114 and a first communication interface 203 (hereafter referred to as an I/F).

The first CPU 118 inputs detection signals from the first inlet sensor 112A and the first outlet sensor 112B and controls operations of the first roll driving section 111A, the first flapper 131A, the first conveying mechanism 113 and the first print head 114 to communicate with the receipt printer 120 through the first communication I/F 203.

The receipt printer 120 includes a second CPU serving as a second control section, a memory 212 serving as a storage device, a second inlet sensor 122A, a second outlet sensor 1223, a second roll driving section 121A, a second flapper 131B, a second recording medium conveying mechanism 123, a second print head 124, a second communication I/F 213 and a control panel 214 serving as an input and output device.

The second CPU 128 inputs detection signals from the second inlet sensor 122A and the second outlet sensor 122B, and controls operations of the second roll driving section 121A, the second flapper 131B, the second conveying mechanism 123 and the second print head 124 to communicate with the label printer 110 and a host computer 220 (hereinafter referred to as a HOST) through the second communication I/F 213 to input and output information through the control panel 214.

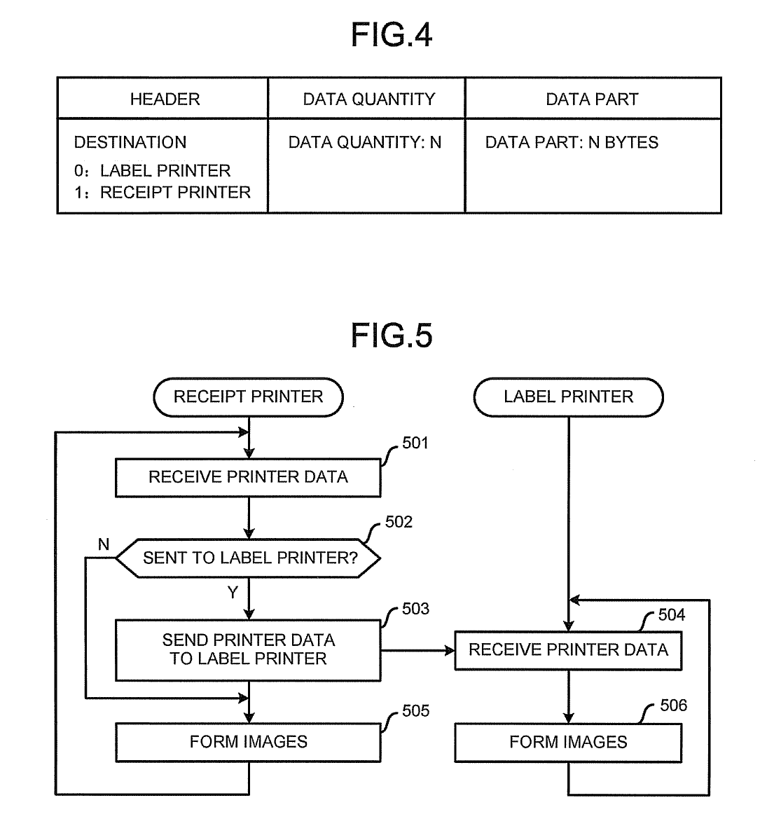

FIG. 4 is a diagram showing an example of the print data sent from the HOST 220 to the image forming apparatus 100. As shown in FIG. 4, the print data contains ‘header’ which represents the identifier of the destination to which data is sent, ‘data quantity’ which represents the number of bytes of the data and ‘data part’ representing the content of data to be printed.

For instance, ‘header’ is ‘0’ representing that the destination is the label printer 110 or ‘1’ representing that the destination is the receipt printer 120, ‘data quantity’ is an integer ‘N’, and ‘data part’ is N-byte print data.

FIG. 5 is a flow chart showing the operations carried out by the image forming apparatus in the normal case. As shown in FIG. 5, in Act 501, the image forming apparatus 100 receives print data from the HOST 220 by the second control section of the receipt printer 120.

In Act 502, the image forming apparatus 100 reads the header of the print data and determines whether or not the print data is sent to the label printer 110 by the second control section of the receipt printer 120. If it is determined that the print data is sent to the label printer 110, the image forming apparatus 100 carries out Act 503, otherwise, carries out Act 505.

In Act 503, the image forming apparatus 100 sends the print data to the label printer 110 by the second control section of the receipt printer 120.

In Act 504, the image forming apparatus 100 receives the print data by the first control section of the label printer 110.

In Act 505, the image forming apparatus 100 forms images by the receipt printer 120 and then returns to Act 501.

In Act 506, the image forming apparatus 100 forms images by the label printer 110 and then returns to Act 501.

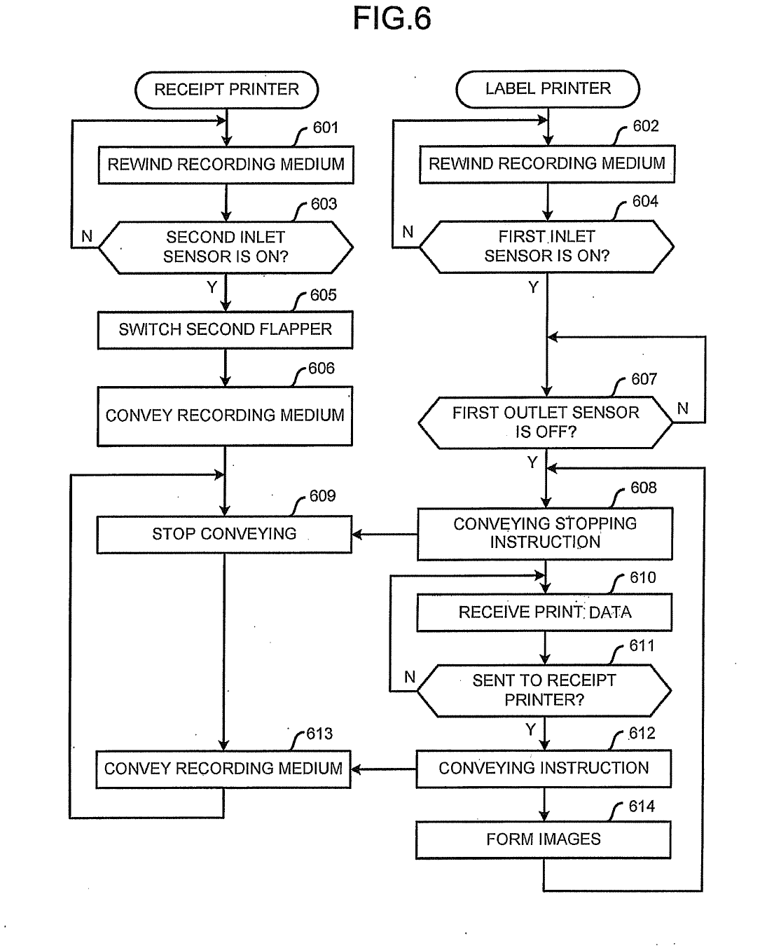

FIG. 6 is a diagram showing operations carried out by the image forming apparatus 100 when the label printer 110 forms images on the second recording medium 121. As shown in FIG. 6, in Act 601, the image forming apparatus 100 drives the second roll driving section 121A in the rewinding direction by the second control section to rewind the second recording medium 121.

In Act 602, the image forming apparatus 100 drives the first roll driving section 111A in the rewinding direction by the first control section which receives an instruction from the second control section to rewind the first recording medium 111.

In Act 603, the image forming apparatus 100 determines whether or not the second inlet sensor 122A is ‘ON’ by the second control section. If it is determined that the second inlet sensor 122A is ‘ON’ by the second control section, the image forming apparatus 100 carries out Act 605, otherwise, returns to Act 601.

In Act 604, the image forming apparatus 100 determines, by the first control section, whether or not the first inlet sensor 112A is ‘ON’. If it is determined that the first inlet sensor 112A is ‘ON’ by the first control section, the image forming apparatus 100 carries out Act 607, otherwise, returns to Act 602.

In Act 605, the image forming apparatus 100 switches the second flapper 131B by the second control section to connect the cross conveying switching path 131 with the recording medium conveying path.

In Act 606, the image forming apparatus 100 drives, by the second control section, the second roll driving section 121A in the take-out direction to convey the second recording medium 121.

In Act 607, the image forming apparatus 100 determines whether the first outlet sensor 112B is ‘OFF’ by the first control section. If it is determined that the first outlet sensor 112B is ‘OFF’, the image forming apparatus 100 carries out Act 608, or returns to Act 607, otherwise.

In Act 608, the image forming apparatus 100 sends a conveying stopping instruction to the second control section by the first control section.

In Act 609, the image forming apparatus 100 stops the second roll driving section 121A by the second control section to stop the convey of the second recording medium 121 in case in which the conveying stopping instruction is received from the second control section.

In Act 610, the image forming apparatus 100 receives print data from the HOST 220 by the first control section through the second control section.

In Act 611, the image forming apparatus 100 reads the header of the print data by the first control section, and determines whether or not the print data is sent to the receipt printer 120. If it is determined that the print data is sent to the receipt printer 120, the image forming apparatus 100 carries out Act 612, or deletes the print data and returns to Act 610, otherwise.

In Act 612, the image forming apparatus 100 sends a recording medium conveying instruction to the second control section by the first control section.

In Act 613, the image forming apparatus 100 drives the second roll driving section 121A in the take-out direction by the second control section to convey the second recording medium 121, and then returns to Act 609.

In Act 614, the image forming apparatus 100 forms images on the second recording medium 121 by the first control section and then returns to Act 608.

As stated above, the image forming apparatus 100 according to the present embodiment includes a first printer in which a first recording medium conveying path is linearly arranged in the horizontal direction, a second printer arranged below the first printer and having a second recording medium conveying path that is linearly arranged in the horizontal direction and a conveying changeover path 130 configured to guide a recording medium loaded on the second printer towards the first printer.

Thus, the present embodiment achieves a technical effect in which, in the case where either one of the print head of the printers is out of order, images can be easily formed on the recording medium loaded on the printer whose print head is out of order.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus, comprising:
a first printer, having a first print head, in which a first recording medium conveying path is linearly arranged in the horizontal direction, the first printer loading a first recording medium therein;
a second printer, having a second print head, in which a second recording medium conveying path is linearly arranged in the horizontal direction, the second printer loading a second recording medium therein; and
a conveying changeover path, arranged between the first printer and the second printer, that is configured to selectively guide the second recording medium loaded in the second printer towards the first print head of the first printer therethrough.

2. The image forming apparatus according to claim 1, wherein
the first printer is arranged below the second printer.

3. The image forming apparatus according to claim 2, wherein
the conveying changeover path includes a switching flapper which switches a recording medium conveying path between a recording medium conveying path passing the conveying switching path and a recording medium conveying path not passing the conveying switching path;
when an instruction is input to instruct the first printer to form images on the recording medium placed in the second printer, the flapper is switched to form the recording medium conveying path passing the conveying switching path to form images on the recording medium placed in the second printer using the first printer.

4. The image forming apparatus according to claim 2, wherein the conveying changeover path includes a switching flapper which switches the recording medium conveying path of the second printer from the second recording medium conveying path to the conveying changeover path or vise versa, wherein the switching flapper is driven so as to convey the second recording medium to the first print head through the conveying changeover path and the first recording medium conveying path if a command that instructs to print an image on the second recording medium by the first printer is input.

5. The image forming apparatus according to claim 4, wherein
the first recording medium is a rolled label sheet, and the second recording medium is a rolled receipt sheet.

6. An image forming method, comprising:
forming an image on a first recording medium loaded in a first printer by the first printer in which a first recording medium conveying path is linearly arranged in the horizontal direction;
forming an image on a second recording medium loaded in a second printer by the second printer in which a second recording medium conveying path is linearly arranged in the horizontal direction; and
driving a switching flapper to form a recording medium conveying path through a conveying changeover path which guides the second recording medium loaded in the second printer to the first printer if a command that instructs to print an image on the second recording medium by the first printer is input, thereby printing an image on the second recording medium by the first printer.

7. The image forming method according to claim 6, wherein
the image is printed according to a print data having an identifier which indicates that the image is printed by either the first printer or the second printer.
